(19) United States
(12) Patent Application Publication
(10) Pub. No.: US 2007/0022973 A1
(43) Pub. Date: Feb. 1, 2007

(54) Edible animal chew resembling naturally occurring substantially unprocessed food source

(76) Inventor: Thomas W. Brown, Shawnee, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/190,471

(22) Filed: Jul. 27, 2005

(51) Int. Cl. A01K 29/00

(52) U.S. Cl. 119/710

(57) ABSTRACT

An edible animal chew for animals, particularly dogs, resembling a naturally occurring substantially unprocessed food source, such as a vegetable, grain, fruit, or animal, in its nutritional content and in one or more of its shape, color, or texture, and wherein the size, hardness, or flavoring of the chew may be changed to accommodate an animal with regard to, for example, the animal's type, age, or size.

### BACKGROUND OF THE INVENTION

1. Field of the Invention

The present invention relates to edible animal chews such as those produced and marketed for pets, particularly dogs. More particularly, the present invention concerns an edible animal chew resembling a naturally occurring substantially unprocessed food source, such as a vegetable, grain, fruit, or animal, in its nutritional content and in one or more of its shape, color, or texture, and wherein the size, hardness, or flavoring of the chew may be changed to accommodate an animal with regard to, for example, the animal's type, age, or size.

2. Description of the Prior Art

It is widely known that animals, particularly dogs, enjoy chewing on animal chews. The prior art includes a variety of such chews and similar treats developed to serve different needs. The most common of these offer some form of benefit to an aspect of an animal's health, such as, for example, a prior art dog chew enriched with ingredients to reduce dental calculus and eliminate odors resulting from poor dental hygiene. Other prior art dog chews include vitamin, mineral, or herbal enhancements to promote good health, such as, for example, a prior art dog chew that includes a substantial amount of carrot.

Prior art dog chews are invariably provided with either arbitrary or functional shapes. Arbitrary shapes include, for example, both realistic and fanciful bone shapes which impart no substantive advantage to the chew. For example, the aforementioned prior art chew containing a substantial carrot component is expressly disclosed as being shaped to resemble a bone. Unfortunately, such shapes may be aesthetically objectionable to some animal owners who may, for example, dislike having a chew with the appearance of a realistic animal bone lying about their houses. Furthermore, arbitrary shapes impart no knowledge or sense of the chew's ingredients or effects.

Functional shapes include, for example, a ribbed shape which, by itself or in conjunction with certain ingredients, functions to improve dental hygiene as the animal's teeth physically act against the shaped chew during chewing. While some functional shapes may impart knowledge of the chew's effects (e.g., improving dental hygiene), the effects of chews with, for example, a purely nutritional purpose are associated with no such functional shape and are therefore provided with the aforementioned arbitrary shapes.

Due to the above-identified and other problems and disadvantages in the prior art, there exists a distinct need for an improved edible animal chew that is both more aesthetically acceptable and imparts some knowledge or sense of the chew's ingredients or effects.

### SUMMARY OF THE INVENTION

The present invention solves the above-identified and other problems and disadvantages in the prior art by providing an edible animal chew for animals, particularly dogs, resembling a naturally occurring substantially unprocessed food source, such as a vegetable, grain, fruit, or animal, in its nutritional content and in one or more of its shape, color, or texture, and wherein the size, hardness, or flavoring of the chew may be changed to accommodate an animal with regard to, for example, the animal's type, age, or size.

The chew may be injection molded or otherwise formed to resemble any of a variety of different naturally occurring substantially unprocessed food sources, such as, for example, a vegetable such as a carrot, an ear of corn, a stalk of celery, or a peapod; a grain such as one or more stalks of wheat; a fruit; or an animal such as a fish. Thus, the chew of the present invention is both aesthetically more acceptable to some animal owners than prior art chews and imparts some knowledge or sense of the chew's ingredients or effects.

The chew broadly comprises a base such as a wheat- or starch-based resin; an amount of the particular food source which the chew resembles or a nutritional additive or additives associated with that food source; a taste-enhancing additive; and a hardness-controlling additive. The base provides a support structure in or on which the other ingredients are suspended or otherwise supported, and allows the chew to be molded into and to retain its shape. The food source or the nutritional additives are ingested when the chew is chewed. The taste-enhancing additives flavor the chew so as to make it more palatable to the particular type of animal it is intended for. If the chew is intended for dogs, for example, then the taste enhancer may contain a flavoring such as meat, cheese, or peanut butter. The hardness-controlling additive allows for softening the chew to a desired degree so as to accommodate, for example, older animals, animals with poor dental structure, or other animals whose ability to chew is diminished.

For example, a chew resembling a carrot in shape, color, and texture, may contain a certain percentage of the following nutrients naturally found in carrots: vitamin A, vitamin C, vitamin B6, potassium, thiamine, folic acid, magnesium, and beta-carotene. The nutrients may be present in the chew because the chew contains an amount of actual carrot or because they have been artificially added to the chew. Similarly, a chew resembling an ear of corn may contain folate, vitamin C, niacin, and thiamine; a chew resembling a stalk of wheat may contain thiamine, riboflavin, niacin, vitamin E, zinc, and iron; a chew resembling a peapod may contain vitamin C, potassium, magnesium, and iron; and a chew resembling a fish may contain Omega-3 fatty acids, amino acids, calcium, iodine, niacin, riboflavin, and vitamin A. The chew may also be enhanced with other nutrients not normally associated with the corresponding food source, including, for example, herbs or other beneficial plants (e.g., green tea) that act as natural antioxidants, diuretics, or lipotropics.

Furthermore, the chew may be enhanced with ingredients to repel insects or provide similar benefits. For example, animals that spend time outside are prone to fleas and other insects which bite and cause irritation. To avoid such discomfort without subjecting the animal to harmful insecticides, the chew may be enhanced with a substance that is safe for the animal to ingest and that acts as an insect repellant when subsequently exuded from the animal.

It is also contemplated that chews of each shape may be scaled to various sizes in order to suit animals of various sizes. Furthermore, it is contemplated that chews resembling a particular food source may be packaged together, or that chews resembling a variety of different food sources may be packaged together.

These and other features of the present invention are described below in greater detail in the section titled DETAILED DESCRIPTION OF THE PREFERRED EMBODIMENTS.

### BRIEF DESCRIPTION OF THE DRAWINGS

A preferred embodiment of the present invention is described in detail below with reference to the attached drawing figures, wherein:

FIG. 1 is a plan view of a preferred embodiment of the chew of the present invention resembling a carrot in shape, color, and texture;

FIG. 2 is a plan view of a preferred embodiment of the chew of the present invention resembling an ear of corn in shape, color, and texture;

FIG. 3 is a plan view of a preferred embodiment of the chew of the present invention resembling stalks of wheat in shape, color, and texture;

FIG. 4 is a plan view of a preferred embodiment of the chew of the present invention resembling a peapod in shape, color, and texture; and

FIG. 5 is a plan view of a preferred embodiment of the chew of the present invention resembling a fish in shape, color, and texture.

### DETAILED DESCRIPTION OF THE PREFERRED EMBODIMENT

With reference to the figures, an animal chew is herein described, shown, and otherwise disclosed in accordance with the preferred embodiments of the present invention. Broadly, the present invention concerns an animal chew for animals, particularly dogs, resembling a naturally occurring substantially unprocessed food source, such as a vegetable, grain, fruit, or animal, in its nutritional content and in one or more of its shape, color, or texture, and wherein the size, hardness, or flavoring of the chew may be changed to accommodate an animal with regard to, for example, the animal's type, age, or size.

The chew may be injection molded or otherwise formed to resemble any of a variety of different naturally occurring substantially unprocessed food sources, such as, for example, a vegetable such as a carrot, an ear of corn, a stalk of celery, or a peapod; a grain such as one or more stalks of wheat; a fruit; or an animal such as a fish. The shape of the chew is directly related to one or more of the nutritional components contained in the chew. Thus, the chew of the present invention is both aesthetically more acceptable to some animal owners than prior art chews and imparts some knowledge or sense of the chew's ingredients or effects.

As used herein, the term “substantially unprocessed” means that little or nothing has been done to “dress” or otherwise prepare the food source following harvesting. For example, a substantially unprocessed carrot might have its top removed but be otherwise unaffected, a substantially unprocessed ear of corn might have its husk removed but be otherwise unaffected, and a substantially unprocessed fish might be entirely unaffected. By contrast, bones and steaks are substantially processed in that they result from multi-step or multi-operation butchering of the originating animal. To be clear: substantially unprocessed, as used herein, encompasses a range of processing extending from entirely unprocessed to minimally processed (i.e., one or two steps or operations). It should be understood, of course, that the chew of the present invention merely appears as or otherwise resembles a substantially unprocessed food source, but in fact the manufacture of the chew may involve substantial processing, i.e., a number of steps or operations.

The chew broadly comprises a base such as a wheat- or starch-based resin; an amount of the particular food source which the chew resembles or a nutritional additive or additives associated with the food source; a taste-enhancing additive; and a hardness-controlling additive. The base provides a support structure in or on which the other ingredients are suspended or otherwise supported, and allows the chew to be molded into and to retain its shape. The food source or the nutritional additives are ingested when the chew is chewed.

The taste-enhancing additive flavors the chew so as to make it more palatable to the particular type of animal it is intended for. Dogs, for example, generally do not eat raw vegetables or fruits, so chews intended for dogs may include a taste enhancer imparting the flavor of, for example, meat, cheese, or peanut butter. The taste enhancer may be natural or artificial.

The hardness-controlling additive allows for softening, or reducing the chewiness of, the chew to a desired degree so as to accommodate, for example, older animals, animals with poor dental structure, or other animals whose ability to chew is diminished. In one contemplated implementation of the present invention, different versions of otherwise substantially identical chews are produced varying only in softness, i.e., how difficult they are to chew. In another contemplated implementation, a single version of the chew is produced and the hardness-controlling additive allows the end-user to vary the softness through some action which activates the hardness-controlling additive. Such an action might involve, for example, microwaving the chew, boiling the chew, or soaking the chew in water.

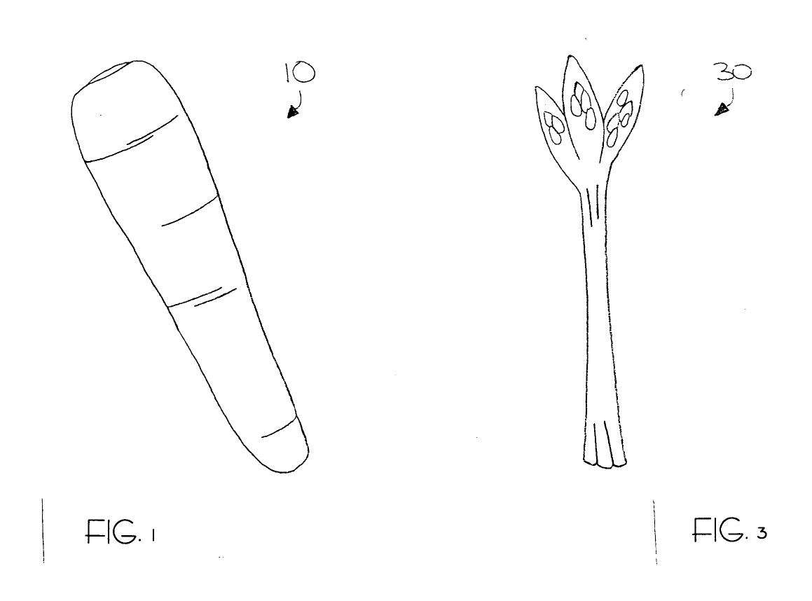

Referring to FIG. 1, for example, the chew 10 is depicted resembling a carrot in shape, color, and texture, and containing the following nutrients naturally found in carrots: vitamin A, vitamin C, vitamin B6, potassium, thiamine, folic acid, magnesium, and beta-carotene. It will be appreciated, for example, that beta-carotene is an important nutrient for improving eyesight and contains anti-oxidants which prevent many diseases including heart disease and many forms of cancer. The nutrients may be present in the chew because the chew contains an amount of actual carrot (e.g., 5%-50%) or because they have been artificially added to the chew. The nutrients are ingested when the chew is vigorously chewed by the animal.

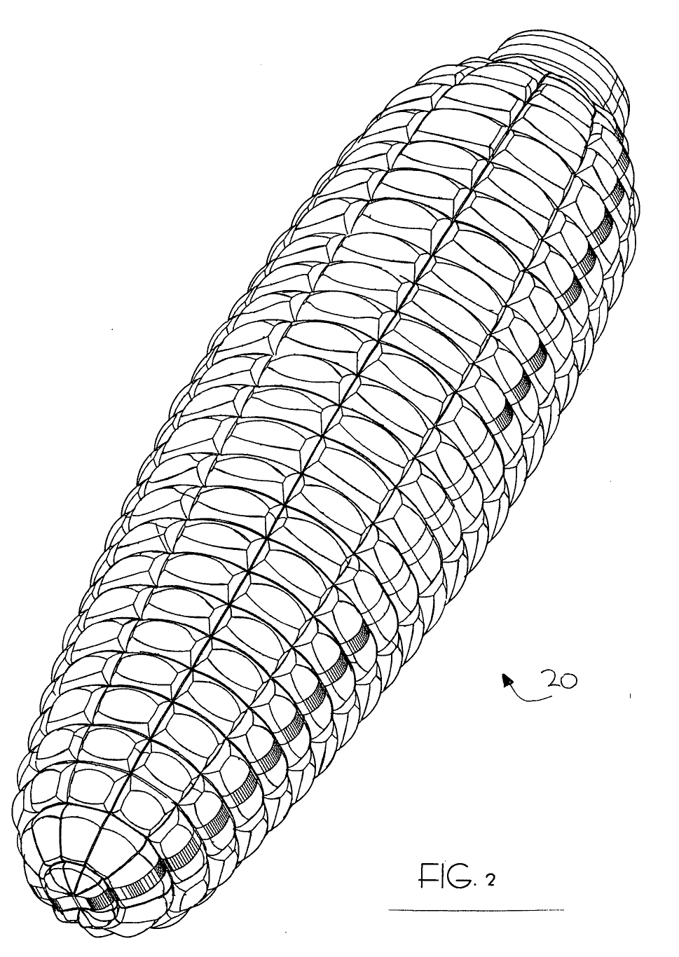

Referring to FIG. 2, for example, the chew 20 is depicted resembling an ear of corn in shape, color, and texture, and containing the following nutrients naturally found in corn: folate, vitamin C, niacin, and thiamine. The nutrients may be present in the chew because the chew contains an amount of actual corn (e.g., 5%-50%) or because they have been artificially added to the chew. The nutrients are ingested when the chew is vigorously chewed by the animal.

Referring to FIG. 3, for example, the chew 30 is depicted resembling stalks of wheat in shape, color, and texture, and containing the following nutrients naturally found in wheat: thiamine, riboflavin, niacin, vitamin E, zinc, and iron.

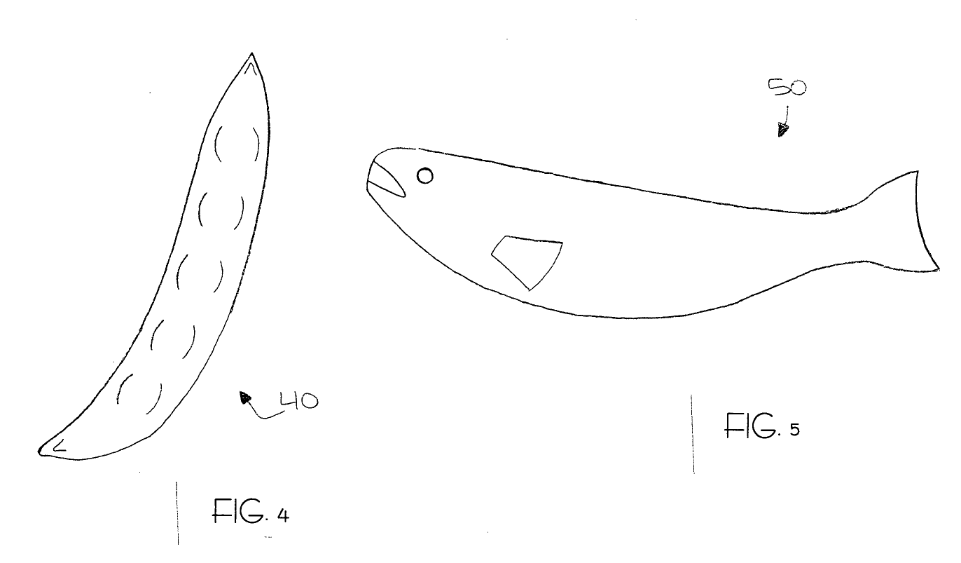

Referring to FIG. 4, for example, the chew 40 is depicted resembling a peapod in shape, color, and texture, and containing the following nutrients naturally found in peas: vitamin C, potassium, magnesium, and iron.

Referring to FIG. 5, for example, the chew 50 is depicted resembling a fish in shape, color, and texture, and containing the following nutrients naturally found in fish: Omega-3 fatty acids, amino acids, calcium, iodine, niacin, riboflavin, and vitamin A. It will be appreciated for example that Omega-3 fatty acids are important for preventing heart disease, decreasing inflammation, and strengthening the immune system.

The chew may also be enhanced with other nutrients or beneficial ingredients not necessarily associated with the food source which the chew resembles, including, for example, herbs or other beneficial plants (e.g., green tea) that act as natural antioxidants which boost the immune system and fight heart disease and cancer; diuretics which help to eliminate unneeded salt and water and thereby make it easier for the heart to pump; or lipotropics which help to burn fat more efficiently.

Furthermore, the chew may be enhanced with ingredients to repel insects or provide similar benefits. For example, animals that spend time outdoors are prone to fleas and other insects which bite and cause irritation. To avoid such discomfort without subjecting the animal to harmful insecticides, the chew may be enhanced with a substance that is safe for the animal to ingest and that acts as an insect repellant when the ingredients or a substance resulting from the ingredients are subsequently exuded naturally through the animal's skin. Such an enhancement ingredient may include, for example, one or more of cinnamon oil, clove oil, corn gluten meal, corn oil, cotton seed oil, garlic oil, lemongrass oil, linseed oil, mint oil, peppermint oil, rosemary oil, sesame oil, sodium chloride, soybean oil, thyme oil, and white pepper. Preferably, the enhancement ingredients are exempt from governmental regulation, including, for example, the requirements of the Federal Insecticide, Fungicide, and Rodenticide Act (FIFRA).

The chew may be enhanced with substantial amounts of carbohydrates or proteins in order to provide working animals with the greater energy and performance ability they require.

It is contemplated that the chew may be scaled to various sizes in order to accommodate animals of various sizes. Smaller animals, for example, will more easily chew and digest smaller chews, while larger animals can chew and digest larger sizes. The sizes may range, for example, from 0.5 ounces to 10.0 ounces or more. Furthermore, it is contemplated both that chews resembling a particular food source may be packaged together so as to allow for providing a particular animal with the particular nutrient or nutrients it may otherwise lack, or that chews resembling a variety of different food sources may be packaged together (a “medley”) so as to allow for providing a particular animal with a variety of different nutrients.

From the preceding description, it will be appreciated that the present invention provides a number of substantial advantages over the prior art, including, for example, that the edible animal chews advantageously resemble a naturally occurring substantially unprocessed food source. This resemblance results in a chew that is both aesthetically more acceptable to some animal owners than prior art chews and imparts some knowledge or sense of the chew's ingredients or effects.

Although the invention has been described with reference to the preferred embodiments illustrated in the drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An animal chew comprising:
(a) a base;
(b) a nutritional content resembling a particular food source; and
(c) a shape and color resembling a naturally occurring substantially unprocessed form of the particular food source.

2. The animal chew as set forth in claim 1, wherein the base is a resin.

3. The animal chew as set forth in claim 1, wherein the particular food source is selected from the group consisting of: vegetables, fruits, grains, and fish.

4. The animal chew as set forth in claim 1, further including a taste-enhancing additive imparting a flavor selected from the group consisting of meat, cheese, and peanut butter.

5. The animal chew as set forth in claim 1, further including a beneficial ingredient selected from the group consisting of: antioxidants, diuretics, and lipotropics.

6. The animal chew as set forth in claim 1, further including a beneficial ingredient selected from the group consisting of: cinnamon oil, clove oil, corn gluten meal, corn oil, cotton seed oil, garlic oil, lemongrass oil, linseed oil, mint oil, peppermint oil, rosemary oil, sesame oil, sodium chloride, soybean oil, thyme oil, and white pepper.

7. An animal chew comprising:
(a) a resin;
(b) an amount of a particular food source;
(c) a taste-enhancing additive for making the animal chew more palatable to an animal;
(d) a hardness-controlling additive for controlling the chewiness of the animal chew; and
(e) a shape and a color resembling a naturally occurring substantially unprocessed form of the particular food source.

8. The animal chew as set forth in claim 7, wherein the particular food source is selected from the group consisting of: vegetables, fruits, grains, and fish.

9. The animal chew as set forth in claim 7, wherein the taste-enhancing additive imparts a flavor selected from-the group consisting of meat, cheese, and peanut butter.

10. The animal chew as set forth in claim 7, wherein the particular food source is a carrot and the shape and the color of the animal chew resembles a naturally occurring substantially unprocessed form-of carrot.

11. The animal chew as set forth in claim 7, wherein the particular food source is a fish and the shape and the color of the animal chew resembles a naturally occurring substantially unprocessed form of fish.

12. The animal chew as set forth in claim 7, further including a beneficial ingredient selected from the group consisting of: antioxidants, diuretics, and lipotropics.

13. The animal chew as set forth in claim 7, further including a beneficial ingredient selected from the group consisting of: cinnamon oil, clove oil, corn gluten meal, corn oil, cotton seed oil, garlic oil, lemongrass oil, linseed oil, mint oil, peppermint oil, rosemary oil, sesame oil, sodium chloride, soybean oil, thyme oil, and white pepper.

14. An animal chew comprising:
(a) a resin;
(b) a nutritional content resembling a particular food source;
(c) a taste-enhancing additive for making the animal chew more palatable to an animal;
(d) a hardness-controlling additive for controlling the chewiness of the animal chew; and
(e) a shape and a color resembling a naturally occurring substantially unprocessed form of the particular food source.

15. The animal chew as set forth in claim 14, wherein the particular food source is selected from the group consisting of: vegetables, fruits, grains, and fish.

16. The animal chew as set forth in claim 14, wherein the taste-enhancing additive imparts a flavor selected from the group consisting of meat, cheese, and peanut butter.

17. The animal chew as set forth in claim 14, wherein the particular food source is a carrot and the shape and the color of the animal chew resembles a naturally occurring substantially unprocessed form of carrot.

18. The animal chew as set forth in claim 14, wherein the particular food source is a fish and the shape and the color of the animal chew resembles a naturally occurring substantially unprocessed form of fish.

19. The animal chew as set forth in claim 14, further including a beneficial ingredient selected from the group consisting of: antioxidants, diuretics, and lipotropics.

20. The animal chew as set forth in claim 14, further including a beneficial ingredient selected from the group consisting of: cinnamon oil, clove oil, corn gluten meal, corn oil, cotton seed oil, garlic oil, lemongrass oil, linseed oil, mint oil, peppermint oil, rosemary oil, sesame oil, sodium chloride, soybean oil, thyme oil, and white pepper.
